(19) United States
(12) Patent Application Publication
(10) Pub. No.: US 2016/0288466 A1
(43) Pub. Date: Oct. 6, 2016

(54) Biopaper for Bags and Wrapping Paper

(71) Applicant: Shantu Patel, Carlsbad, CA (US)

(72) Inventor: Shantu Patel, Carlsbad, CA (US)

(21) Appl. No.: 14/677,935

(22) Filed: Apr. 2, 2015

(51) Int. Cl. B32B 27/10; B32B 29/00; B32B 27/36; B32B 37/00; B32B 1/02; C09J 5/00; B32B 37/12; B32B 7/12; B32B 27/32

(52) U.S. Cl. CPC B32B 27/10; B32B 7/12; B32B 29/002; B32B 27/36; B32B 27/32; B32B 1/02; C09J 5/00; B32B 37/12; B32B 37/0053; B32B 2250/02; B32B 2255/12; B32B 2307/7163; B32B 2439/00

(57) ABSTRACT

A biopaper for bags and wrapping paper includes a first layer having a bioplastic resin; and a second layer having a thin paper; wherein the first layer and second layer are adhered together to form a sheet of multilayered biopaper. A method of making biopaper includes providing a bioplastic film that includes a bioplastic resin selected from the group consisting of PLA, PLLA, PDLA, PHA, PCL, PH, PBT, GPE, and GPET; providing a lightweight paper; applying a bio adhesive to a side of the lightweight paper; adhering the side of the lightweight paper to the bioplastic film to provide a multilayer paper; and rolling the multilayer paper against a main roller so as to further adhere the lightweight paper and bioplastic film together.

### BACKGROUND OF THE INVENTION

The present invention generally relates to biodegradable products and more specifically to biopaper for bags and wrapping paper.

The earth's environment and sustainability have become increasingly important factors in the design and specification of disposable single use items and their safe disposal after use. Due to higher social responsibility and environmental concerns, corporations are being driven to produce more sustainable and environmentally safe products through government regulations, by institutional investors, and through consumer demand.

Paper and plastic are common raw materials used to manufacture of all types of single use disposable bags (i.e. grocery, lunch, food service, and pharmacy) and wrapping paper. Paper is considered environmentally friendly for it is derived from plants. Plastic however may not be environmentally friendly because it is derived from fossil fuel and is from a non-renewable resource. Single use grocery plastic bags and other single use plastic items are being banned by certain municipalities and at certain venues, and more recycling is encouraged. We therefore have to use the most sustainable packaging materials. Paper used in the manufacturing of bags and wrapping paper is made from heavier weight paper to make them tear resistant, thus more sustainable option than low weight paper. Bioplastic films can be used to replace plastic to overcome the sustainability issues to make bags and wrapping material. However, thin bio plastic film and low weight paper are more susceptible to tearing. Low weight paper is also more susceptible to moisture damage and wrinkling

Currently paper bags come in several different paper grades, including natural brown and bleached white Kraft, oatmeal, flipside, beater-dyed, white claycoat and synthetic. The paper can be virgin, recycled paper or recycled newspaper, they also come in coated and uncoated textures. Weights vary from 20# to 184# for the synthetic bags, which do not crack and yield superior holding strength. Some companies order paper bags with print and artwork, which is done in various colors, inks and print styles. Based upon wood, a natural renewable resource, paper is biodegradable and recyclable and a source of energy after use. The pulp and paper industry is well fitted to meet the challenge of sustainable development, from the forest through the production of pulp and paper and finally through recycling.

Embodiments of bio paper could be recyclable and compostable thus environmentally superior over regular paper and plastic. The addition of starch as a dry strength additive improves the properties of recycled paper. Poly-Lactic Acid (PLA), a product from bio-refinery process, has recently been shown to act as a promising strength additive that could be used in combination with starch to further improve the strength of paper. In this study, the use of PLA of three molecular weights (MW) in combination with four different starches was investigated. Three recycled pulps from different origins, with the kappa number of 27.9 to 66 were used. Paper handsheets were made, and selected paper properties were tested. The results indicate that handsheets properties were influenced by the MW of PLAs, the type of starch used, and the lignin content of the pulp. The paper handsheets made from lignin-rich pulp (pulp A, kappa number 66), combined with 0.1% medium MW PLA (PLA_1) and 0.9% cationic starch containing 0.43% N gave the highest improvement for tensile strength, wet tensile strength, air and water resistance. This result verifies that a higher kappa number pulp has better attraction to the hydrophobic PLA. Moreover, the higher charge cationic starch led to higher tensile strength due to the increase of affinity to the anionic fiber surface. Interestingly, results show that amphoteric starch is a promising substitute for high cationic charge starch when combined with the medium MW PLA to improve tensile strength of paper. This study demonstrated that a starch-PLA blend represents a promising approach in improving properties of recycled paper.

Bioplastic resins have been used in various products, namely, bottles, forks, knives, plates, and medical products including test tubes, infusion sets, catheters, tubing, syringes, collection bags, gowns, surgical drapes and wound dressing materials, bottles, container, and diapers.

It would be desirable to overcome the issues related to low weight paper and plastic.

### SUMMARY OF THE INVENTION

In one aspect of the present invention, a biopaper includes a first layer having a bioplastic resin; and a second layer having a thin paper; wherein the first layer and second layer are adhered together to form a sheet of multilayered biopaper.

In another aspect of the present invention, a method of making biopaper includes providing a bioplastic film that includes a bioplastic resin selected from the group consisting of PLA, PLLA, PDLA, PHA, PCL, PH, PBT, GPE, and GPET; providing a lightweight paper; applying a bio adhesive to a side of the lightweight paper; adhering the side of the lightweight paper to the bioplastic film to provide a multilayer paper; and rolling the multilayer paper against a main roller so as to further adhere the lightweight paper and bioplastic film together.

### BRIEF DESCRIPTION OF THE DRAWINGS

FIG. 1 is a schematic view of an embodiment of a method of making a biopaper according to the present invention; and

FIG. 2 depicts an embodiment of a biopaper according to the present invention.

### DETAILED DESCRIPTION

The preferred embodiment and other embodiments, which can be used in industry and include the best mode now known of carrying out the invention, are hereby described in detail with reference to the drawings. Further embodiments, features and advantages will become apparent from the ensuing description, or may be learned without undue experimentation. The figures are not necessarily drawn to scale, except where otherwise indicated. The following description of embodiments, even if phrased in terms of “the invention” or what the embodiment “is,” is not to be taken in a limiting sense, but describes the manner and process of making and using the invention. The coverage of this patent will be described in the claims. The order in which steps are listed in the claims does not necessarily indicate that the steps must be performed in that order.

Embodiments of the present invention generally provide a bio paper or biopaper made from paper and bioplastic. Embodiments of the present invention generally relate to manufacturing bio paper sheets. Embodiments may provide multilayer bio plastic and paper sheets bonded by bio based adhesive. Embodiments may be produced in pairs with almost no peel strength and thus having excellent separation to derive two sheets of biopaper.

Embodiments may include a bio paper with two (bi), environmentally friendly materials that are biodegrade (bio) that compostable in an industrial composting unit. Bio paper may be derived from paper and bioplastic, provide the advantages of paper and plastic properties in one material, and yet be environmentally friendly. Bio paper may help overcome the issues related to low weight paper and plastic.

Embodiments of a biopaper may include a two layered, paper and plastic. Embodiments may be manufactured by layering low weight (2 to 40 lbs. or 3 to 60 g/m2) paper and bio resin film (0.2 mil to 20 mil or 5 micron to 500 micron) derived from bioresins. The two are adhered by using a clear or opaque bio based adhesive, or they can heated to achieve bonding. To improve strength, avoid tearing, and improve moisture properties, multilayers can be used, for example two to six or higher. Improvements may also be achieved by using higher weight paper and thicker bio plastic film, and maintaining the two layer process over multilayers.

Embodiments of bio paper may have both paper and plastic properties in one sheet, offering improved tensile strength, burst index and strain at folds. Embodiments of bio paper may be compostable and thus environmentally friendly, unlike plastic sheets, thereby helping overcome end of life issues that plastic bags create.

Embodiments of the present invention may include bioplastics resins or bioresins, namely, polylactic acid (PLA) and heat stable PLA (PLLA, PDLA), cellulose based PH, polybutylene adipate terephthalate (PBT) and polycaprolate (PCL) from corn and cellulose, green polyethylene (GPE), and green polyethylene terephthalate (GPET) from sugarcane. PHA (polyhydroxyl alkanoate) is derived by plant fermentation. Poly L lactide (PLLA) and poly D lactide (PDLA) are forms or homo-polymers of PLA. Bioresins such as PLA, (PLLA, PDLA), PHA, PCL, PH, PBT, GPE, and GPET may be used to make biaxial films.

Embodiments of the present invention may include bioplastic resins, which have some distinct advantages over plastic. Bioplastic has a smaller carbon footprint compared to plastic, and may require less total energy to form an article like a film or sheet. Bioplastics are biodegradable in an industrial composting unit. Bioplastic resins are from a plant source, and when plants are grown, they absorb carbon dioxide, thus decreasing carbon dioxide in the atmosphere.

Items made from bio plastic resin, namely, PLA, PHA, PH, and PCL PCH, are all biodegradable, and are compostable. PLA derived polymers such as PLLA and PDLA offer higher heat distortion properties can also be used. Embodiments of bio paper derived from PLA, PHA, PH, PCL PCH are compostable and can be diverted from land field. Bio paper made with bio resins such as GPE and GPET may not biodegradable, but they are heat stable, and since they are from a plant source, they offer upstream advantages. Other heat stable bioplastics may include PLLA, PDLA, PHA, GPE and GPET.

Embodiments of the present invention may have improved biodegradability and sustainability by using known paper types in a much lighter weight to make bio paper. Because the same paper is being used, but in much lighter weight layered with bio plastic, printing and artwork can be done on one or both sides.

Embodiments of bio paper could be used as the material for several main paper bag styles, including serrated top, folded top, die cut, macramé and knotless macramé. The serrated top bag is the most common and the most economical; some come with paper twist and bio plastic tube handles. There are two types of folded-top bags, ultra-modular and JV slit. The die-cut bag has a serrated or folded top. The knotted and knotless macramé bags come in four styles: 1½-inch top fold, soft-handled with an inside patch, the slit top and the ultra, which has a value-added smooth finish. The size, shape and paper weight can vary.

Embodiments of the present invention may include bio paper bags, such as grocery and shopping bags, manufactured with angulated bottoms and handles by continuously moving a bio paper forward in a rotary-type manufacturing machine. Two types of machines may be used for manufacturing shopping bags with handles. One is a rotary-type machine that feeds bio paper wound in a roll. The other is a sheet-fed type that feeds bio paper cut to a predetermined size. The process flow of a bag includes a bio paper feeding process, a cuts making process, a pasting process, a reinforcing pasting process, a material cutting process, and a top edge portion pasting and folding process, respectively. If heat is an issue, heat stable bioplastic may be used to facilitate the manufacturing process.

Embodiments of bioplastic wrapping paper may include papers which are used for the purpose of packaging or wrapping to pack or wrap articles such as shoes, garments, toys, handicrafts, fruits, gifts, candy, flowers etc. Embodiments may include papers of varied quality, shapes, and textures. These can be plain, printed, glazed, rough, colored or white. The thickness or density of the paper may be 14, 17, 20, 30, 35, 60, 80, 100 grams per square meter (GSM), depending upon the intended nature and type of use. However, generally 17 GSM White MF Paper may be used to pack garments, shoes, candy, fruits etc. and printed glossy paper around 80 GSM may be used for gift and toys packing. In an embodiment the bio plastic used for wrapping application may be heat stable.

Embodiments of a biopaper may have varying properties based on paper quality, paper weight, and type and thickness of bioplastic used. Thus bio paper be vary in bulk, density, tensile strength, tensile stiffness, heat distortion, tensile index, breaking length, stretch properties, moisture resistance, moisture permeation, burst index, strain at folds, Bendtsen roughness and printability.

Embodiments of the bio adhesive used can also can also impact the properties mentioned above for example, a natural rubber adhesive can increase or improve tensile index, burst index, moisture resistance and strain at folds.

Embodiments of the main roller surface may be smooth or the surface may have roughness and texture that may vary to change the bonding properties based on the adhesive used. This will vary the end product quality in terms of bonding properties and roughness and texture of the bio paper derived.

Embodiments of the present invention include methods for manufacturing bio paper sheets. Embodiments may provide multilayer bio plastic and paper sheets bonded by bio based adhesive with little or almost no peel strength and thus having excellent separation to derive two sheets of bio paper.

Embodiments may include lightweight paper that may vary from 2 lbs. to 40 lbs. or 3 g/m² to 60 g/m², and bioplastic film that may vary from 0.5 mil to 20 mil.

An embodiment of a system and method of preparing bio paper sheets may include using bioplastic film and lightweight paper according to the present invention. Embodiments may prepare a single layer made of lightweight paper and a bioplastic film, bonded together using a bio based adhesive, into a single multilayer bio paper sheet. Pairs of sheets may be prepared in a mirrored system and then separated into two sheets. The output bio paper may be used to manufacture articles such as bags, wrapping paper, or packaging paper, or could be stored on rolls for later use.

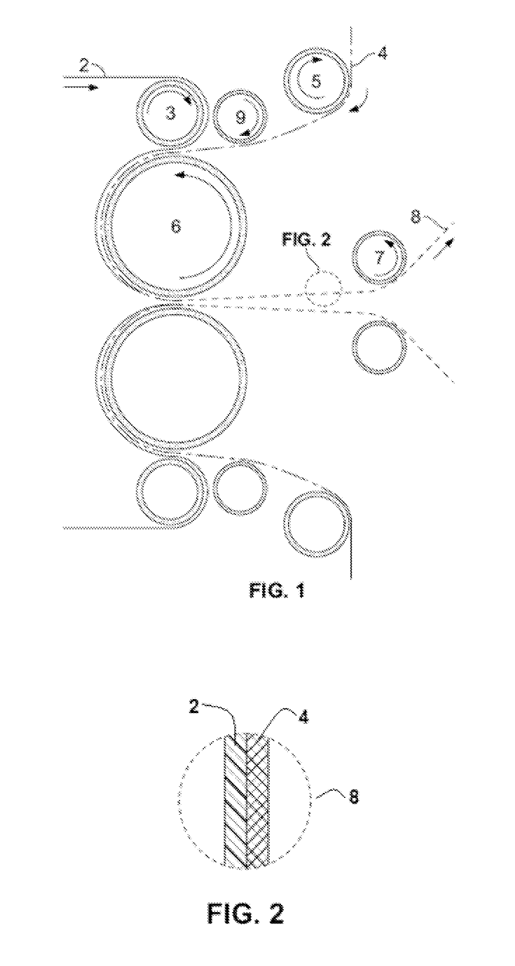

FIG. 1 schematically illustrates an embodiment of a methodology of deriving bio paper. Reference numerals 3,5, 6, 7 and 9 denote rollers. Main roller is denoted as 6, feeding rollers are denoted as 3 and 5, and the adhesive application roller is 9. Bioplastic film 2 and lightweight paper 4 pass over the feeding rollers 3 and 5 respectively. In an embodiment of a continuous feeding mechanism, the light paper passes over adhesive roller 9, thereby giving it an adhesive coat. The adhesive coated lightweight paper and bioplastic film pass over the main roller 6 to produce a single sheet of bio paper 8. As depicted in FIG. 1, the manufacturing mechanism may be duplicated in a mirror image of the apparatus mentioned above, to produce two bio paper sheets at once. This will add capacity and increase the number of bio paper sheets produced.

As depicted in the embodiment of FIG. 1, bioplastic film 2 and lightweight paper 4 are fed into a manufacturing apparatus, and adhered together to produce bio paper 8. The bioplastic film 2 may be drawn into the system with a feeding roller 3. The lightweight paper 4 may be drawn in with a second feeding roller 5, and then the paper pass against an adhesive roller 9, which applies an adhesive coat to the one side of the paper. The lightweight paper 4 with adhesive coating and the and bio film 2 may be adhered together and held against a main roller 6 to form a sheet of bio paper 8. The paper and film may be held together so they will adhere by tension created by the feeding rollers 3 and 5 and output roller 7, and may also be pressed together between the film feeding roller 3 and the main roller 6. The finished sheet of bio paper 8 may be drawn out of the system with an output roller 7.

An embodiment the manufacturing apparatus and rollers may be duplicated so that two sheets of bio paper are simultaneously prepared. In a mirrored system, the film and paper may also be pressed together between the mirrored pair of main rollers, and then the two sheets may be separated and drawn away from each other by the mirrored output rollers. The system may continuously feed thin paper and bioplastic film, and output two continuous streams of biopaper. The system is a continuous feeding system in that if inputs are continuously fed in, output will continuous be produced.

FIG. 2 is a schematic illustration of an embodiment of bio paper with two layers. FIG. 2 shows that bio paper 8, such as that produced by the manufacturing apparatus of FIG. 1, may include a layer of bioplastic film 2 and layer of lightweight paper 4. The biodegradable film and thin paper may be adhered together with a thin coating of bio based adhesive, heated to achieve bonding, or otherwise bonded to form a multilayer biopaper for bags and wrapping paper.

Embodiments of the present invention include multilayered bio paper derived from paper and bio plastic resin, such as two or more layers. Embodiments include bio paper derived from bioplastics namely, PLA, PLLA, PDLA, PHA, PCL, PH, PBT, GPE, and GPET. Embodiments include a bio adhesive to bond bioplastic and light weight paper. Embodiments include bags derived from bio paper and wrapping and packaging paper derived from bio paper. Embodiments include a methods of making bio paper

I claim:

1. A biopaper, comprising:
a first layer having a bioplastic resin; and
a second layer having a thin paper;
wherein the first layer and second layer are adhered together to form a sheet of multilayered biopaper.

2. The biopaper of claim 1, further comprising:
a second sheet of multilayered biopaper that includes a layer of bioplastic resin and a layer of thin paper;
wherein the first sheet and second sheet are lightly bound together with a low peel strength so that the first sheet and second sheet are adapted to be separated.

3. The biopaper of claim 1, wherein the first layer and second layer are adhered together with a bio adhesive.

4. The biopaper of claim 1, wherein the bioplastic resin includes polylactic acid (PLA).

5. The biopaper of claim 1, wherein the bioplastic resin includes poly-L-lactide (PLLA).

6. The biopaper of claim 1, wherein the bioplastic resin includes poly-D-lactide (PDLA).

7. The biopaper of claim 1, wherein the bioplastic resin includes polyhydroxyl alkanoate (PHA).

8. The biopaper of claim 1, wherein the bioplastic resin includes polycaprolate (PCL).

9. The biopaper of claim 1, wherein the bioplastic resin includes cellulose based PH.

10. The biopaper of claim 1, wherein the bioplastic resin includes polybutylene adipate terephthalate (PBT).

11. The biopaper of claim 1, wherein the bioplastic resin includes green polyethylene (GPE).

12. The biopaper of claim 1, wherein the bioplastic resin includes green polyethylene terephthalate (GPET).

13. The biopaper of claim 1, wherein the biopaper is formed into a bag.

14. The biopaper of claim 1, wherein the biopaper is wrapping paper.

15. The biopaper of claim 1, wherein the biopaper is packaging paper.

16. The biopaper of claim 1, wherein the thin paper has a density of 3 GSM to 60 GSM, and the layer of bioplastic resin has a thickness of 0.2 mil to 20 mil.

17. A method of making biopaper, comprising:
providing a bioplastic film that includes a bioplastic resin selected from the group consisting of PLA, PLLA, PDLA, PHA, PCL, PH, PBT, GPE, and GPET;
providing a lightweight paper;
applying a bio adhesive to a side of the lightweight paper;
adhering the side of the lightweight paper to the bioplastic film to provide a multilayer paper; and
rolling the multilayer paper against a main roller so as to further adhere the lightweight paper and bioplastic film together.

18. The method of claim 17, further comprising:
utilizing a first feeder roller to draw the bioplastic film into a continuous feeding system;
utilizing a second feeder roller to draw the lightweight paper into the continuous feeding system;
utilizing an adhesive application roller to apply the bio adhesive to the side of the lightweight paper; and
utilizing an output roller to draw the multilayer paper out of the continuous feeding system.

19. The method of claim 18, wherein the first feeder roller also presses the bioplastic film against the lightweight paper.

20. The method of claim 18, further comprising:
providing a second continuous feeding system as described in claim 17, thereby providing a first feeder system and second feeder system;
aligning the main roller of the first feeder system to the main roller of the second feeder system so that the multilayer paper of the first feeder system is pressed against the multilayer of the second feeder system; and
utilizing the output roller of the first feeder system and the output roller of the second feeder system to separate the multilayer paper of the first feeder system away from the multilayer paper of the second system.
